(19) United States
(12) Patent Application Publication
(10) Pub. No.: US 2017/0071181 A1
(43) Pub. Date: Mar. 16, 2017

(54) FISHING POLE FISH BITE DETECTOR AND ALERTING DEVICE

(71) Applicant: Larry D. Briggs, Layton, UT (US)

(72) Inventor: Larry D. Briggs, Layton, UT (US)

(21) Appl. No.: 14/855,081

(22) Filed: Sep. 15, 2015

(51) Int. Cl. A01K 97/12

(52) U.S. Cl. CPC A01K 97/125

(57) ABSTRACT

A device is which alerts a fisher of a pull on the line (typically caused by a fish bite) is disclosed. The device includes a triggering arm pivotally mounted and placed between two contacts with fishing line placed under the arm. The arm acts to electrically isolate the two contacts when placed between them. The device may include a power source and one or more switches for an audible and/or visual alarm. The two contacts are part of the electrical circuit and complete the circuit when they touch. If a fish bites, the tension on the line will cause the upward movement of the non-conductive arm, allowing the contacts to touch and close the circuit to cause an alert that may be audible and/or visual.

### BACKGROUND OF THE INVENTION

1. The Field of the Invention

The present invention relates to fishing accessories. More specifically, the present invention relates to a device used to detect and alert a user of movement of fishing line.

2. State of the Art

Fishing is a pastime that usually requires some patience, as it can take substantial amounts of time between an angler casting the line out and the time a fish bites the bait or lure. However, as soon as a fish does bite, attention must be given to the line to properly set the hook and to reel the fish in or the catch may be lost. Thus, a fisherman must pay attention to his fishing line for long periods of time. Various devices have been used to help a fisherman to know when a bite is on the line. This can allow a fisherman to cast his line out and then go about other activities in the vicinity without having to pay so much attention to the line.

Some of these devices may interfere with the function of the fishing pole, such as a device that does not clear the line after it has alerted the fisherman. One example is attaching a bobber to the line along the fishing pole. A device like this may be a hindrance at the critical time when a fish is being reeled in. Additionally, various factors may occur that would affect the sensitivity of a device that detects the pull of a fish, such as movement of the water, buoyancy of the fishing line, wind and waves and the type of bait or lure attached to the line. When these factors are not considered, alerting devices could experience a force on the line sufficient to give a false positive alert to indicate a strike by a fish.

Thus, there is a need for a new device to alert a fisherman of a strike by a fish on the line.

### SUMMARY OF THE INVENTION

According to one aspect of the present disclosure, a fish bite detector device is provided which may include a housing or base, the housing or base having a non-conductive triggering arm pivotally mounted thereon. The triggering arm may be pivotable between a lowered position (where it rests between two conductive contacts) and a raised position.

According to another aspect, two metal contacts may be mounted adjacent the triggering arm. An electrical circuit is provided that includes a power source, an alerting device, such as a signal generator, such that when the metal contacts are sufficiently close to allow flow of a current through the circuit, the signal generator emits at least one human perceptible signal.

According to another aspect, the triggering arm may be provided with a plurality of guide slots at different distances from the fulcrum of the triggering arm. The guide slots may receive the fishing line as it is placed beneath the triggering arm to thereby allow a user to adjust the force necessary to cause the triggering arm to pivot from the lowered position to the raised position.

According to another aspect, the housing is provided with at least one switch. The switch may act to close a circuit that includes the two contacts, causing the two contacts and triggering arm to act as a switch. In some configurations, one switch is provided to close a circuit that includes a visual indicator and another switch is provided to close a circuit that includes an audible indicator.

According to yet another aspect, the housing may include a battery-powered circuit, with an alerting light source and/or audible alarm electrically connected thereto. The battery may be located within the base or housing.

According to another aspect, the force on the line sufficient to move the triggering arm upward may alternatively be adjusted by use of one or more adjusting screws that move the two contacts closer to each other, and/or increase the pressure between the two contacts.

While the present disclosure identifies numerous aspects which may be included in the fishing pole bite alerting device, it will be appreciated that some or all of these aspects may not be necessary to practice other aspects of the present disclosure and may therefore be omitted. The scope of the invention is intended to be measured by the appended claims.

### BRIEF DESCRIPTION OF THE DRAWINGS

Various embodiments of the present invention are shown and described in reference to the numbered drawings wherein:

FIG. 1 shows a perspective view of a device for detecting and alerting a fisherman of a bite on a fishing line according to the description herein;

FIG. 2 shows a perspective view of the triggering arm tower and triggering arm receiving tower of FIG. 1;

FIG. 3 shows a side, partial cut-away view of the triggering arm receiving tower of FIGS. 1 and 2;

FIG. 4 shows a top view of a possible configuration for an electrical circuit described herein;

FIG. 5 shows a side view of a fishing pole mounted above a device as described herein;

FIG. 6 shows a side view of a fishing pole mounted with a device as described herein, with the line of the fishing pole placed under the triggering arm of the device; and

FIG. 7 shows a perspective view of the triggering arm tower and triggering arm receiving tower of FIG. 6 with a fishing line placed beneath the triggering arm.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention and elements described herein should not be read into the claims except as specifically discussed therein.

### DETAILED DESCRIPTION

The following description includes various representative embodiments and specific details in order to provide a thorough understanding of the present disclosure. The skilled artisan will understand, however, that the methods and devices described below can be practiced without employing these specific details, or that they can be used for purposes other than those described herein. Indeed, they can be modified and can be used in conjunction with products and techniques known to those of skill in the art in light of the present disclosure.

Reference in the specification to “one configuration,” “one embodiment” “one aspect” or “a configuration,” “an embodiment” or “an aspect” means that a particular feature, structure, or characteristic described in connection with the configuration may be included in at least one configuration and not that any particular configuration is required to have a particular feature, structure or characteristic described herein. The appearances of the phrase “in one embodiment” or similar phrases in various places in the specification are not necessarily all referring to the same configuration, and may not necessarily limit the inclusion of a particular element of the invention to a single configuration, rather the element may be included in other or all configurations discussed herein. Thus it will be appreciated that the claims are not intended to be limited by the representative configurations shown herein. Rather, the various representative configurations are simply provided to help one of ordinary skill in the art to practice the inventive concepts claimed herein.

The invention and accompanying drawings will now be discussed in reference to the numerals provided therein so as to enable one skilled in the art to practice the present invention. The drawings and descriptions are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

Furthermore, the described features, structures, or characteristics of configurations of the invention may be combined in any suitable manner in one or more configurations. In the following description, numerous specific details are provided, such as examples of products or manufacturing techniques that may be used, to provide a thorough understanding of configurations of the invention. One skilled in the relevant art will recognize, however, that configurations or embodiments of the present disclosure may be practiced without one or more of the specific details, or with other methods, components, materials, and so forth. In other instances, well-known structures, materials, or operations are not shown or described in detail to avoid obscuring aspects of the invention.

Prior to discussing particular configurations, it should be understood that the present invention is not limited to any particular structures, process steps, or materials discussed or disclosed herein, but is extended to include equivalents thereof as would be recognized by those of ordinary skill in the relevant art. More specifically, the invention is defined by the terms set forth in the claims. It should also be understood that terminology contained herein is used for the purpose of describing particular aspects of the invention only and is not intended to limit the invention to the aspects or configurations shown unless expressly indicated as such. Likewise, the discussion of any particular aspect of the invention is not to be understood as a requirement that such aspect is required to be present apart from an express inclusion of the aspect in the claims.

It should also be noted that, as used in this specification and the appended claims, singular forms such as “a,” “an,” and “the” may include the plural unless the context clearly dictates otherwise. Thus, for example, reference to “a spring” or “a damping mechanism” may include one or more of such springs or damping mechanisms, and reference to “the layer” may include reference to one or more of such layers.

As used herein, the term “substantially” refers to the complete or nearly complete extent or degree of an action, characteristic, property, state, structure, item, or result to function as indicated. For example, an object that is “substantially” enclosed would mean that the object is either completely enclosed or nearly completely enclosed. The exact allowable degree of deviation from absolute completeness may in some cases depend on the specific context, such that enclosing the nearly all of a battery in a housing would be substantially enclosed, even if the housing enclosing the battery had an opening or channel formed along a portion thereof. The use of “substantially” is equally applicable when used in a negative connotation to refer to the complete or near complete lack of an action, characteristic, property, state, structure, item, or result. For example, structure which “substantially frees a fishing line” would either completely free the fishing line or so nearly completely free the fishing line that the effect would be effectively the same as if it completely freed the fishing line.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Concentrations, amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

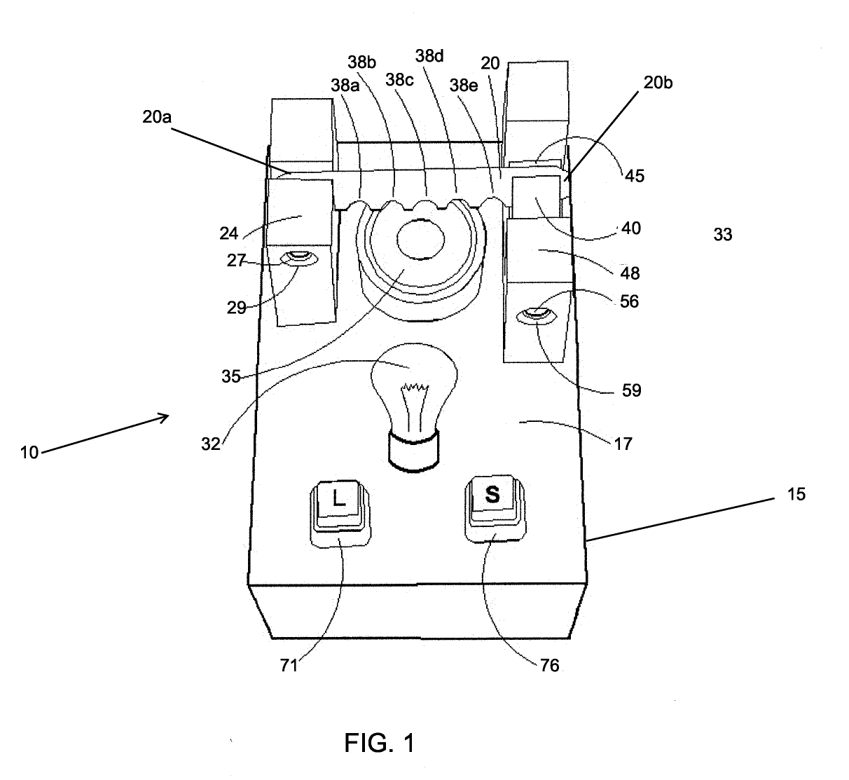

Turning now to FIG. 1, there is shown a perspective view of an apparatus for signaling movement of a fishing line caused by the pull of a fish, generally indicated at 10. The apparatus includes a base 15, with a triggering arm 20, at least a portion of which is non-conductive or covered by a non-conductive material, pivotally mounted to the base 15. Adjacent the triggering arm 20, two electrical contacts are provided. The electrical contacts may be, for example, metal contact plates 40, 45 or other types of contacts The electrical contacts are part of an electrical circuit that may be interrupted by the triggering arm 20. A fishing line may be placed beneath the triggering arm 20, with the triggering arm 20 held frictionally between the two contacts 40, 45. When the line moves due to a strike by a fish, the triggering arm 20 may pivot upwardly, releasing the line, and closing the circuit. The circuit may include an alerting device such that the alerting device is powered when the circuit is closed and the fisherman is alerted that a fish is on the line.

The triggering arm 20 may be pivotally mounted to the base 15 in any suitable manner. In one configuration, the triggering arm 20 may be pivotally mounted to the upper surface 17 of the base 15 via a triggering arm tower 24. The triggering arm tower 24 may include a generally U-shaped body defining with a void for receiving a proximal end of the triggering arm 20, with a screw 27 that passes through the triggering arm tower 24 and the proximal end 20a of the triggering arm. The screw 27 acts as the pivot point, or fulcrum, of the triggering arm 20. The triggering arm tower 24 may also include a recessed hole 29 for receiving the screw 27. The pivotable attachment at the proximal end 20a of the triggering arm 20 may allow the triggering arm 20 to pivot in a plane perpendicular to the base 15.

The triggering arm 20 may be pivotable between an open position, wherein the triggering arm is not between contacts 40, 45, and a closed position (as seen in FIG. 1), wherein the triggering arm 20 is between contacts 40, 45. In the closed position, the triggering arm 20 may be held in place frictionally with the distal end 20b held between a first contact 40 and second contact 45 so that a non-conductive portion of the triggering arm avoids current passing between the contacts. The first and second contacts 40, 45, as described below, comprise a portion of an electrical circuit. Thus, in the closed position, the non-conductive portion of the distal end 20b of triggering arm 20 interrupts or opens the electrical circuit. When the triggering arm 20 pivots upward to an open position, the circuit is closed by the contacts coming sufficiently close to pass current between them.

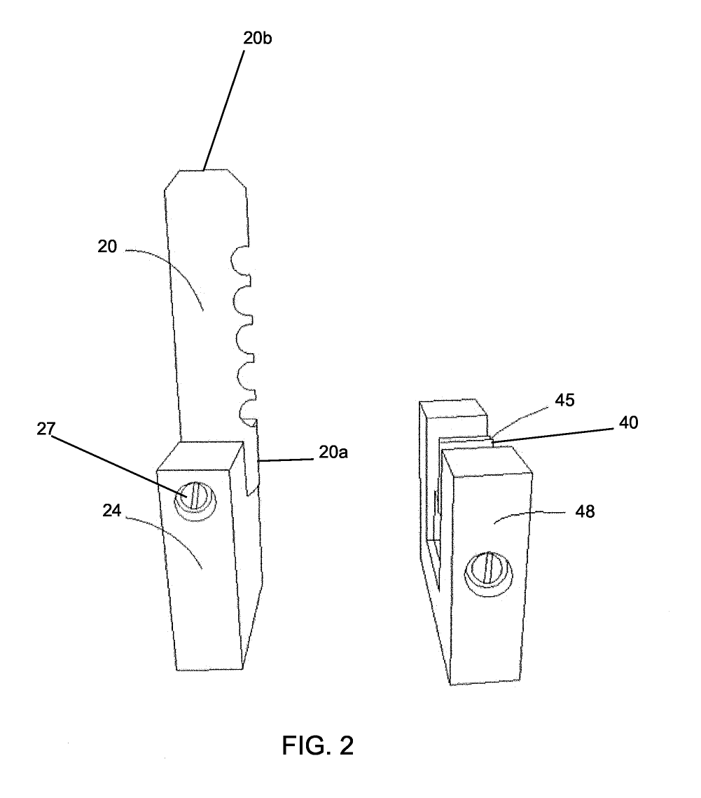

Additionally, in the closed position, there may be a space or holding area 33 created between the triggering arm 20 and the base 15 for receiving a fishing line (fishing line not shown in FIG. 1). When the triggering arm 20 is in an open position, a fishing line may be placed in this holding area 33, and the triggering arm 20 pivoted into the closed position. When the line is pulled due to a strike, etc., the line may move upwardly, causing the triggering arm 20 to also pivot upwardly. As the triggering arm 20 pivots upwardly from the closed position, the fishing line becomes free from the holding area 33 and clear of the device 10. The movement of the non-conductive portion of the arm out from between the contacts also means that the circuit is complete, allowing current to flow—thereby activating a signal generation device , such as a visual generator (light, etc.) or an audible generator (speaker, chime, etc.). The configuration shown in FIG. 1 includes both a light 32 and a speaker 35. FIG. 2 shows a perspective view of the triggering arm tower 24 and the triggering arm receiving tower 48 (other structures are omitted for clarity) with the triggering arm 20 in an open position.

The triggering arm may also include one or more guide slots 38a-e for receiving fishing line. It will be appreciated that while a guide slot 38 may provide guidance for the fishing line, the guide slot is not a necessary. One or more guide slots may be formed along the bottom edge of the triggering arm 20. In some configurations, one guide slot may be provided. In other configurations, additional guide slots may be provided to allow additional adjustment to the force necessary to cause the triggering arm to pivot from the closed position to the open position. For example, guide slots placed farther from the pivot point at screw 27 of the triggering arm 20 (such as guide slot 38e) require less force to move the triggering arm 20 than guide slots placed closer to the pivot point at screw 27 of the triggering arm 20 (such as guide slot 38a) because the arm acts as a lever. Thus, with a plurality of guide slots at varying distances from the pivot point, an angler may choose, based on conditions such as wind, movement of the water, type of lure used, etc., what force may be preferable to move the triggering arm 20 upward. For example, on a windy day, it may be desirable to have a larger force necessary to move the triggering arm upward (to prevent false positive movement of the triggering arm 20 due to wind forces).

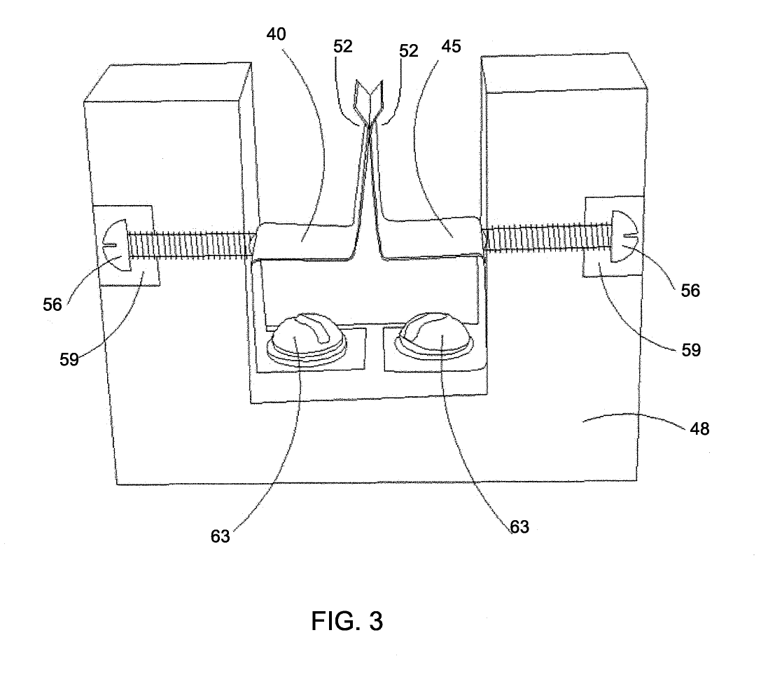

The device 10 also comprises an electrical circuit; the electrical circuit including two electrical contacts located adjacent the triggering arm, such as two contacts (e.g. metal contact plates 40, 45). The two contacts 40, 45 may be mounted to the base 15 in any suitable manner. In one configuration, the metal contact plates 40, 45 are mounted to the base 15 via a triggering arm receiving tower 48. FIG. 3 shows a side, partial cut-away view of the triggering arm receiving tower 48. The triggering arm receiving tower 48 may include a generally U-shaped, with the two metal contacts 40, 45 placed in the void created by the U-shaped body. The triggering arm receiving tower may be comprised of non-conductive material.

The two contacts 40, 45 may each include a bend 52, with such bend created in each at the same or nearly the same respective location, as can be seen in FIG. 3. The bend 52 may create a small point of contact between the two contact plates, which creates a slim point of margin for the electrical current to pass through. It may also act as a guide for placement of the triggering arm 20. As the triggering arm 20 is placed into a closed position, it may be lowered into and held in place between the contacts 40, 45 at the bend 52 in the plates to create an open circuit.

In some configurations, the pressure between the contacts 40, 45 may be adjustable. For example, as shown in FIG. 3, the pressure between the two contacts 40, 45 may be adjusted by adjusting screws or bolts 56 provided for one or both contacts 40, 45. The adjusting screws 56 may be located within a recess 59 of the triggering arm receiving tower 48. The adjusting screws 56, when turned inward, may force the two contacts 40, 45 towards each other to create more pressure at the bend 52 or point of contact. This in turn increases the force or pull necessary to cause the triggering arm to pivot upwardly from its closed position between the contacts 40, 45 to an open position.

The contacts 40, 45 may be connected to the electrical circuit via conductive screws or bolts 63 that pass through the contact plates and into the base 15, connecting the plates to the power source, for example, by electrical leads. In some configurations, the circuitry, including the power source and electrical leads, may be located in a chamber within the base 15. In other configurations, all or portions of the circuitry may be exposed. It may be preferable to place the circuitry within a chamber of the base 15 to provide some protection from exposure. In some configurations, the base 15 may be substantially waterproof and/or shock absorbent to provide further protection to the circuitry of the device.

The circuit may also include one or more alarm switches connected to one or more alerting devices or signal generators. For example, the circuitry may include a switch, such as a toggle switch that controls a visual alert, such as a light source that generates a visual signal.

Another example may be a toggle switch that controls an audible alert, such as a speaker that generates an audible signal. In the configuration shown in FIG. 1, the device 10 is provided with both an alarm switch 71 for a light or visual signal generator and an alarm switch 76 for a speaker or audible signal generator. This may allow an angler to choose one or both alerts depending on the circumstances. For example, when fishing in the dark or in low light and quiet is desired, a visual alert may be preferred. Alternatively, if one is out of visual sight of the pole, an audible alert may be preferred. In some circumstances, both the audible and the visual alerts may be preferred.

Pressing the switch for the audible alert may close the circuit connecting the power supply to the speaker. The circuit includes the two contacts 40, 45. Thus, when the triggering arm 20 is in a closed position between the contact plates, the circuit is interrupted and no power flows to the speaker. However, when the fishing line experiences a pull due to a fish striking, it moves the triggering arm upwardly and the two contacts 40, 45 touch and the circuit is closed, causing power to flow to the speaker and the audible alarm to sound. Similarly, pressing the switch for the visual alert may close the circuit, which includes the two contacts 40, 45.

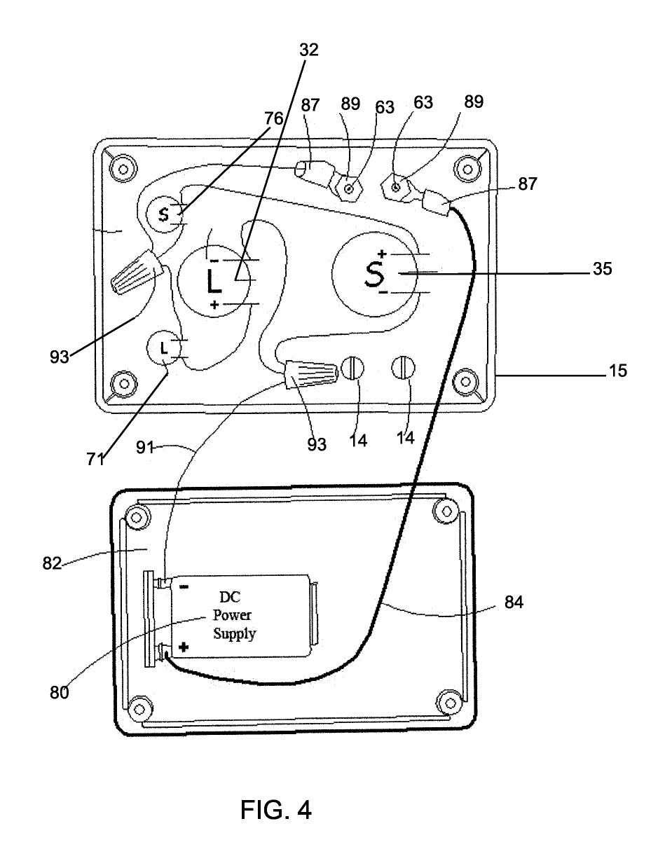

FIG. 4 gives an example of a circuitry configuration that may be used with the device. This figure is given by way of example, as other circuitry configurations are possible and contemplated herein. As shown in FIG. 4, the power supply 80, such as a DC power supply, may be attached to the base 15 via a base cover plate 82. The power supply may be disposed on or near the base 15, or located in a chamber within the base 15. A positive wire lead 84 may travel from the power supply to the base 15, to a lead fastener 87, and to the metal bolt 63 that secures the first contact to the triggering arm receiving tower 48. It may be fastened with a metal nut 89.

Next, a negative wire lead 91 may travel from the power supply to the base 15, and then be split into two negative wire leads by a nut 93. This split may allow for more than one type of signal generator to be provided. For example, both an audible and/or a visual alert may be set on the device. If only one alert or signal generator were provided, the split would not be necessary. Similarly, if additional alerts were desired, more splits could be provided. One split of the negative wire lead may travel through an audible alert, such as speaker 35, and then through a toggle switch or audible alarm switch 76. The second negative wire lead may similarly travel through a visual alert, such as light 32, and then through a toggle switch or visual alarm switch 71. The split negative wire leads may then be joined together by a nut 93′ and travel to a lead fastener 87′. The negative wire lead may then be fastened to the metal bolt 63 that secures the second contact to the triggering arm receiving tower 48. It may be fastened with a metal nut 89′. FIG. 4 also shows two screws 14 which may be used to secure the triggering arm tower 24 to the base 15.

A wiring configuration like this may allow either or both of the alarm switches to be depressed or otherwise switched to close the circuit. The closed circuit allows the negative side of the electrical current to travel unobstructed from the power supply through one or more of the alerting devices, to the second contact. Similarly, the positive side of the electrical current travels unobstructed through the wire lead to the first contact. This turns the metal contacts 40, 45 into an electrical switch. With the two contacts 40, 45 in contact with each other, the entire electrical circuit is closed. With the non-conductive portion of the triggering arm 20 in place between the first and second contacts 40, 45, the circuit is open.

Depending on the type of alert desired, a fisherman may choose to either depress the switch 71 for the visual alert or the switch 76 for the audible alert. Pressing or otherwise actuating the switch 71 closes the circuit that includes the light 32, the power source 80, and the two contacts 40, 45 (through the bolts 63 shown in FIG. 4), allowing the contacts with the triggering arm 20 to become a switch for the circuit. Similarly, pressing or otherwise actuating the switch 76 for the audible alert closes the circuit that includes the speaker 35, the power source 80, and the two contacts 40, 45, allowing the contacts with the triggering arm 20 to become a switch for the circuit.

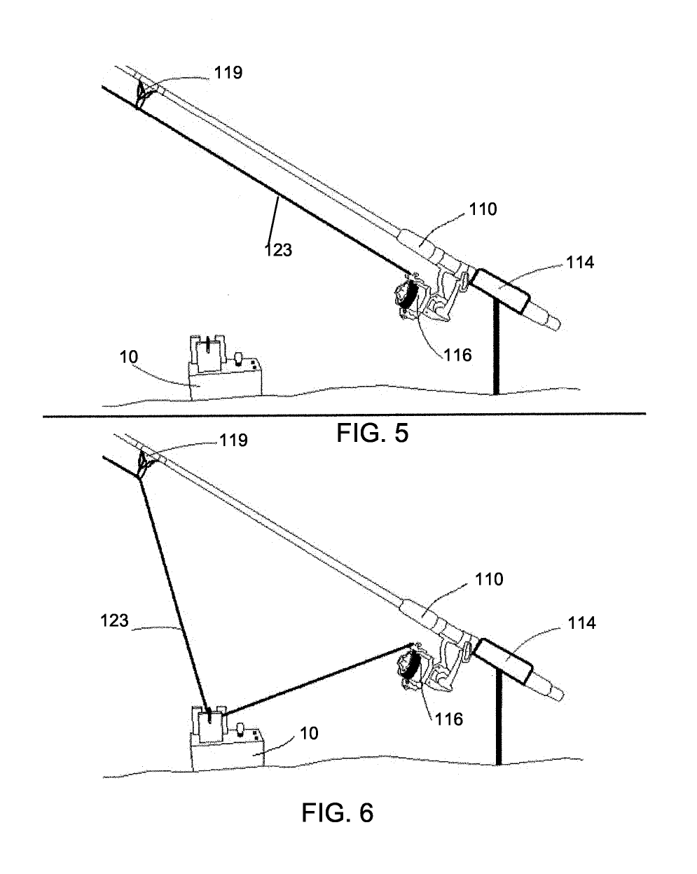

In use, an angler may first cast out his line at a desired location, and then place his pole, either by use of a pole holder, a rock, tree branch, etc. As shown in FIG. 5, the pole 110 is held in place by a pole holder 114. The device 10 may then placed underneath the pole 110, usually between the fishing reel 116 and the first fishing line eyelet 119 of the pole. With the switches for the one or more alerting devices set to the open or off position, and the triggering arm 20 pivoted to an open position, the slack of the fishing line 123 may be placed under the triggering arm 20. If desired, the fisherman may choose the appropriate fishing line guide slot on the bottom edge of the triggering arm according to the force desired to cause the triggering arm to pivot upwardly (a slot closer to the triggering arm tower 24 requiring more force on the line to pivot the triggering arm upwardly than a slot farther from the triggering arm tower 24).

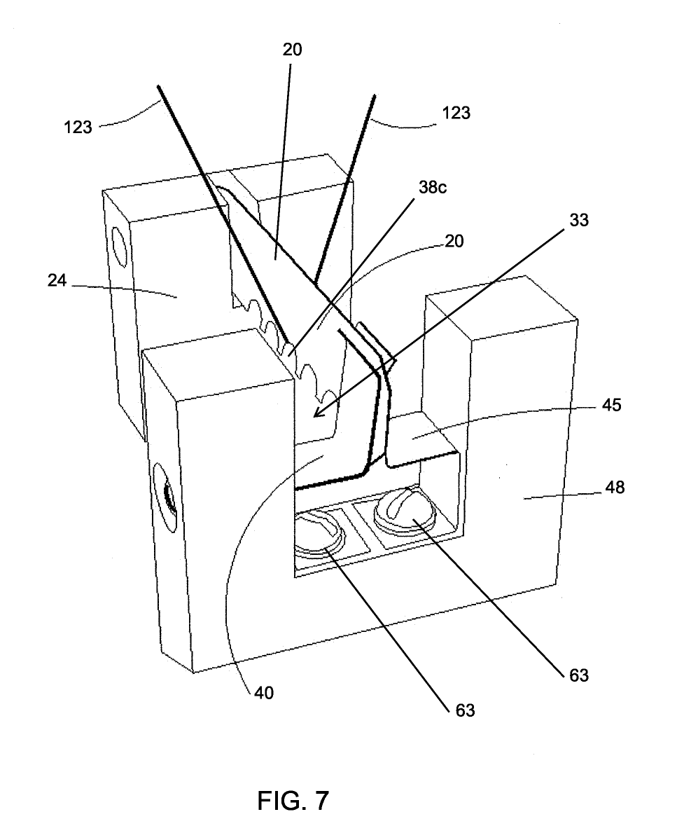

With the fishing line under it, the triggering arm may then be placed between the first and second contacts 40, 45, creating an open circuit when the power source is activated. If desired, the fisherman may also adjust the adjusting screws adjacent the contacts 40, 45 on the triggering arm receiving tower 48 to adjust the force necessary to free the triggering arm from between the contacts 40, 45. FIG. 6 shows a side view of the device 10 in place with the fishing line 123 set under the triggering arm 20. FIG. 7 shows a perspective view of a triggering arm tower 24 and a triggering arm receiving tower 48 (other structures omitted for clarity) with a fishing line 123 in place beneath a triggering arm 20. The triggering arm 20 may be held in place between the contacts 40, 45. As shown in FIG. 7, the fisherman has chosen to place the fishing line 123 through the guide slot 38c.

With the fishing line 123 in place, the fisherman may then activate a signal generator, such as either visual and/or audible alarms by pushing the proper switch. By pushing the switch, the circuit receives power from the power source 80 and the path of current travels to the contacts 40, 45 (and is interrupted by the non-conductive portion of triggering arm 20). The triggering arm 20 may be held in place frictionally between the first and second contacts 40, 45, creating an open circuit. When a fish bites the tackle, the line 123 may be pulled and move upwardly from the bite detector device 10. As the line 123 moves upwardly, it may also move the triggering arm 20 upwardly. The triggering arm 20 may be moved from its closed position between the contacts 40, 45, which simultaneously or nearly simultaneously may free the fishing line 123 and activate the alarm. Without the non-conductive triggering arm between the first and second contacts 40, 45, the contacts are able to touch and close the circuit. The closed circuit allows the electricity to flow to the audible and/or visual alerts to alert the fisherman that a fish is on the line.

Additionally, as the triggering arm pivots upwardly, the fishing line becomes clear of the device 10, and the device 10 does not interfere further with the fishing pole's regular functions.

Disclosed herein is an apparatus for signaling movement of a fishing line caused by the pull of a fish, comprising a base; a triggering arm pivotally mounted to the base and moveable between a first open position, and a second closed position wherein the triggering arm extends between a first contact and a second contact to electrically isolate the first contact and the second contact, a space for receiving the fishing line formed between the triggering arm and the base when the triggering arm is the second closed position; and an electrical circuit comprising an electrical source, the first contact and second contact, and one or more signal generators, the electrical circuit being configured to activate at least one of the one or more signal generators when the triggering arm is moved from the second closed position to the first open position.

The base may comprise a chamber, and the electrical source may be located within the chamber of the base. The triggering arm may be pivotable between the closed position wherein the fishing line is held between the triggering arm and the base and the open position wherein the fishing line is released. The triggering arm may be held in place frictionally between the first contact and second contact in the closed position. The triggering arm may be non-conductive and interrupt the electrical circuit in the closed position.

The apparatus may further comprise screws for adjusting a pressure between the first and second contacts. The circuit may further comprise one or more signal generator switches. The triggering arm may comprise one or more guide slots for receiving the fishing line. The one or more guide slots comprises a plurality of guide slots located at varying distances from a pivotable connection point of the triggering arm. The triggering arm may be moved from the second closed position to the first open position when the fishing line experiences a pull.

A fishing signaling device is described comprising: a base having an upper surface; a triggering arm pivotally mounted on the upper surface of the base, the triggering arm having a first, open position and a second, closed position wherein the triggering arm and the base forming a holding area for a fishing line; a first contact and a second contact comprising an electrical circuit, the second, closed position of the triggering arm electrically isolating the first contact and second contact; at least one signal generator connected to the electrical circuit, wherein a pull on the fishing line causes the triggering arm to pivot from the second, closed position to the first, open position, closing the electrical circuit. The base may further comprise a chamber, and a power source may be located within the chamber. The electrical circuit may further comprise electrical leads connecting the power source to the at least one signal generator and the first and second contacts, the electrical leads located within the chamber.

In some configurations, the at least one signal generator may comprise an audible signal generator and a visual signal generator. The electrical circuit may comprise a first electrical switch for the audible signal generator and a second electrical switch for the visual signal generator. The triggering arm may comprise a bottom edge, the bottom edge having one or more guide slots for receiving the fishing line. The triggering arm may include one or more guide slots for receiving the fishing line, the one or more guide slots comprises a plurality of guide slots located at varying distances from a pivotable connection point of the triggering arm.

Also disclosed herein is a method for signaling the bite of a fish on a fishing line, comprising selecting a device comprising a base; a triggering arm pivotally mounted to the base adjacent a first contact and a second contact, a space for receiving a fishing line formed between the triggering arm and the base when the triggering arm is in a closed position between the first contact and the second contact; and an electrical circuit comprising an electrical source, the first and second contacts, and one or more signal generating devices, wherein the electrical circuit is completed when the triggering arm pivots to an open position; placing the fishing line in the space for receiving a fishing line; and placing the triggering arm in the closed position.

The device may further comprise an electrical switch connected to the electrical circuit and the method includes the step of actuating the electrical switch. The one or more signal generating devices may comprise an audible alerting device and a visual alerting device, and the device further comprises a first electrical switch connected to the audible alerting device and a second electrical switch connected to the visual alerting device, and the method includes the step of choosing to actuate the first electrical switch or the second electrical switch. The triggering arm may also include a bottom edge having a plurality of guide slots thereon and the method includes the step of choosing a guide slot to place the fishing line in.

Thus there is disclosed a fishing pole bite detector and alerting device. Those skilled in the art will appreciate that there are numerous modifications which can be made without departing from the scope and spirit of the invention. The appended claims are intended to cover such modifications.

What is claimed is:

1. An apparatus for signaling movement of a fishing line caused by the pull of a fish, comprising
a base;
a triggering arm pivotally mounted to the base and moveable between a first open position, and a second closed position wherein the triggering arm extends between a first contact and a second contact to electrically isolate the first contact and the second contact, a space for receiving the fishing line formed between the triggering arm and the base when the triggering arm is the second closed position; and
an electrical circuit comprising an electrical source, the first contact and second contact, and one or more signal generators, the electrical circuit being configured to activate at least one of the one or more signal generators when the triggering arm is moved from the second closed position to the first open position.

2. The apparatus according to claim 1, wherein the base comprises a chamber, and the electrical source is located within the chamber of the base.

3. The apparatus according to claim 1, wherein the triggering arm is pivotable between the closed position wherein the fishing line is held between the triggering arm and the base and the open position wherein the fishing line is released.

4. The apparatus according to claim 1, wherein the triggering arm is held in place frictionally between the first contact and second contact in the closed position.

5. The apparatus according to claim 1, wherein the triggering arm is non-conductive and interrupts the electrical circuit in the closed position.

6. The apparatus according to claim 1, wherein the apparatus further comprises screws for adjusting a pressure between the first and second contacts.

7. The apparatus according to claim 1, wherein the circuit further comprises one or more signal generator switches.

8. The apparatus of claim 1, wherein the triggering arm comprises one or more guide slots for receiving the fishing line.

9. The apparatus of claim 8, wherein the one or more guide slots comprises a plurality of guide slots located at varying distances from a pivotable connection point of the triggering arm.

10. The apparatus of claim 1, wherein the triggering arm is moved from the second closed position to the first open position when the fishing line experiences the pull.

11. A fishing signaling device comprising:
a base having an upper surface;
a triggering arm pivotally mounted on the upper surface of the base, the triggering arm having a first, open position and a second, closed position wherein the triggering arm and the base forming a holding area for a fishing line;
a first contact and a second contact comprising an electrical circuit, the second, closed position of the triggering arm electrically isolating the first contact and second contact ;
at least one signal generator connected to the electrical circuit,
wherein a pull on the fishing line causes the triggering arm to pivot from the second, closed position to the first, open position, closing the electrical circuit.

12. The device of claim 11, wherein the base further comprises a chamber, and wherein a power source is located within the chamber.

13. The device of claim 12, the electrical circuit further comprising electrical leads connecting the power source to the at least one signal generator and the first and second contacts, the electrical leads located within the chamber.

14. The device of claim 13, wherein the at least one signal generator comprises an audible signal generator and a visual signal generator.

15. The device of claim 14, wherein the electrical circuit comprises a first electrical switch for the audible signal generator and a second electrical switch for the visual signal generator.

16. The device of claim 11, wherein the triggering arm comprises a bottom edge, the bottom edge having one or more guide slots for receiving the fishing line.

17. The device of claim 11, wherein triggering arm comprises one or more guide slots for receiving the fishing line, the one or more guide slots comprises a plurality of guide slots located at varying distances from a pivotable connection point of the triggering arm.

18. A method for signaling the bite of a fish on a fishing line, comprising
selecting a device comprising a base; a triggering arm pivotally mounted to the base adjacent a first contact and a second contact, a space for receiving a fishing line formed between the triggering arm and the base when the triggering arm is in a closed position between the first contact and the second contact; and an electrical circuit comprising an electrical source, the first and second contacts, and one or more signal generating devices, wherein the electrical circuit is completed when the triggering arm pivots to an open position;
placing the fishing line in the space for receiving a fishing line; and
placing the triggering arm in the closed position.

19. The method according to claim 18, wherein the device further comprises an electrical switch connected to the electrical circuit and the method includes the step of actuating the electrical switch.

20. The method according to claim 18, wherein the one or more signal generating devices comprise an audible alerting device and a visual alerting device, and the device further comprises a first electrical switch connected to the audible alerting device and a second electrical switch connected to the visual alerting device, and the method includes the step of choosing to actuate the first electrical switch or the second electrical switch.

21. The method according to claim 18, wherein the triggering arm includes a bottom edge having a plurality of guide slots thereon and the method includes the step of choosing a guide slot to place the fishing line in.
